(19) United States
(12) Patent Application Publication
(10) Pub. No.: US 2008/0185097 A1
(43) Pub. Date: Aug. 7, 2008

(54) Positive displacement plural-component finishing dispenser system and method

(75) Inventor: Bradley Paul Walter, Superior, CO (US)

Correspondence Address: Tait R. Swanson;FLETCHER YODER, P.O. Box 692289, Houston, TX, 77269-2289, US

(73) Assignee: Illinois Tool Works Inc.

(21) Appl. No.: 11/703,357

(22) Filed: Feb. 7, 2007

(51) Int. Cl. C09J 5/00

(52) U.S. Cl. 156/307.5; 156/390

(57) ABSTRACT

According to an embodiment of the present technique, there is provided a plural component finishing dispenser system including a multi-cartridge support configured to receive a plurality of finishing component cartridges in a proportion to control a mixture ratio of a plurality of different finishing components, a drive configured to displace fluid at an equal linear rate in the plurality of finishing component cartridges, and an outlet for each different finishing component. There is further provided a method for positively displacing different finishing substances at an equal linear rate independently through different cartridges at a cartridge ratio that controls a downstream mixture ratio of the different finishing substances.

### BACKGROUND

The invention relates generally to a plural component dispensing system, and more particularly to a system for dispensing paint components to an applicator.

Many high-performance paints used today on automotive, aerospace, and industrial equipment include two or more components, where the two major components are commonly known as paint and hardener. These plural component paints are generally more durable and have better gloss and color retention than single component or air-drying paints.

Many plural component paints are mixed in batches prior to application. Once the hardener is mixed with the paint, these mixed batches typically must be used within a short time span known as the pot life. The pot life is the length of time the mixed paint is usable, that is, the time before the batch of paint has hardened or thickened so much that it can no longer be applied evenly to a surface. After the pot life has expired, the paint is generally discarded as hazardous waste. Even before the pot life has expired, viscosity and other paint characteristics change over time, leading to defects in the finish.

In addition to the problems associated with pot life in mixed batches, this technique is very time-consuming. The painter must spend valuable time measuring exact quantities of each component and mixing paint thoroughly. If the paint is not accurately measured and properly mixed, in the correct ratio the paint will not cure properly, or the paint's physical properties may be adversely affected. Finally, mixing the paint components exposes the painter and other bystanders to materials present in the components.

### BRIEF DESCRIPTION

There is provided a finishing dispenser system, including a multi-cartridge support configured to receive a plurality of finishing component cartridges in a proportion to control a mixture ratio of a plurality of different finishing components, a drive configured to displace fluid at an equal linear rate in the plurality of finishing component cartridges, and an outlet for each different finishing component.

There is further provided a finishing dispenser system, including a multi-cartridge support having a plurality of uniformly sized tubular finishing component receptacles configured to receive non-uniformly sized tubular finishing component cartridges, and a drive configured to displace a plurality of pistons at an equal linear rate within the plurality of receptacles.

There is further provided a finishing dispenser system, including a multi-cartridge support having a plurality of receptacles, a plurality of finishing component cartridges disposed in the plurality of receptacles, wherein the finishing component cartridges independently hold different finishing components, and wherein a mixture ratio of the different finishing components is based on a cartridge ratio of the finishing component cartridges having the different finishing components, and a drive configured to displace contents of the finishing component cartridges for subsequent mixing in the mixture ratio as the different finishing components flow and merge downstream.

There is further provided a method, including positively displacing different finishing substances at an equal linear rate independently through different cartridges at a cartridge ratio that controls a downstream mixture ratio of the different finishing substances.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a liquid dispensing system according to an embodiment of the present technique;

FIG. 2 is a block diagram of a liquid dispensing system having a spray device according to an embodiment of the present technique;

FIG. 3 is a block diagram of a liquid dispensing system having a spray device according to an alternative embodiment of the present technique;

FIG. 4 is a perspective view of a liquid supply system according to an embodiment of the present technique;

FIG. 5 is an exploded view of the liquid supply system of FIG. 4;

FIG. 6 is a top view of the liquid supply system of FIG. 4;

FIG. 7 is a cross-sectional view of the liquid supply system of FIG. 4 taken along line 7-7 of FIG. 6; and

FIG. 8 is a perspective view of a liquid dispensing system according to an embodiment of the present technique.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present technique relates to dispensation of a plural component finishing product, such as plural component paint, having two or more components that mix together. For illustrative purposes, the components may include “liquid A” and “liquid B.” For example, liquid A may include a catalyst component, such as a hardener. Liquid B may include a pigmented component, such as paint or resin. In each of the embodiments discussed herein, the designation of liquid A and liquid B may be exchanged. For example, liquid A may be the paint component and liquid B may be the hardener component. In either arrangement, the techniques discussed herein will perform in substantially the same manner. Different plural component systems use different ratios of liquid A to liquid B. In the embodiments described below, the ratio of liquid A to liquid B may be controlled in a precise manner by using cartridges containing the liquids A and B in a cartridge ratio that defines the mixture ratio of liquid A to liquid B. Moreover, the contents of the cartridges may be positively displaced by pistons, for example, at an equal flow rate to ensure that the mixture ratio is constant during flow of the liquids A and B.

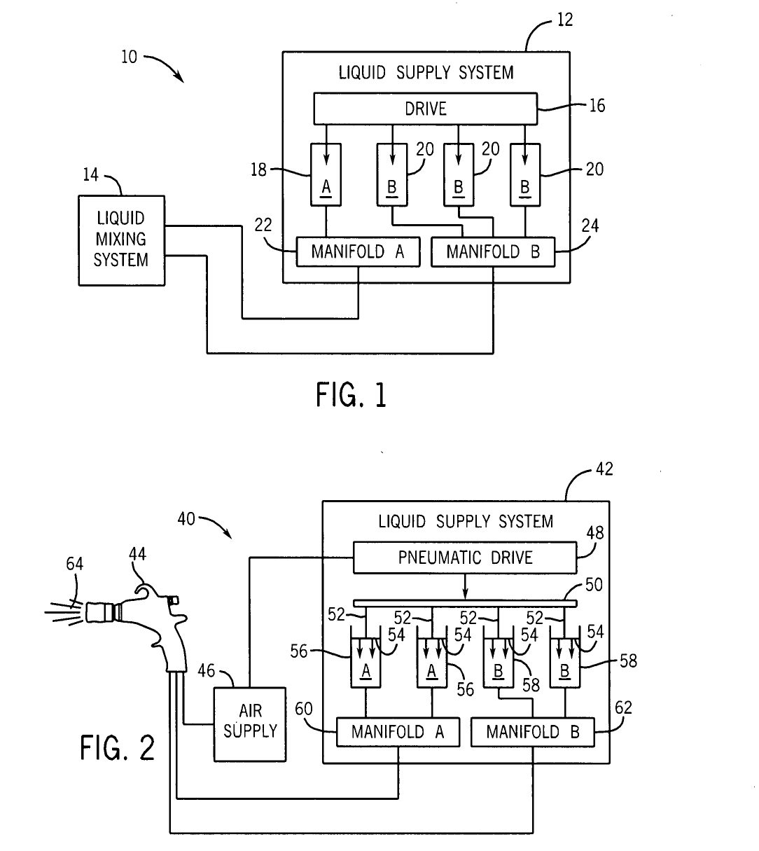

FIG. 1 is a block diagram of a liquid dispensing system 10 according to an embodiment of the present technique. The liquid dispensing system 10 includes a liquid supply system 12 and a liquid mixing system 14. The liquid supply system 12 has a drive 16 which is used to displace liquids A and B from cartridges 18 and 20 to manifolds 22 and 24, respectively. In certain embodiments, the system 12 may include a positive displacement system having pistons that positively displace contents within the cartridges 18 and 20 in response to the drive 16. Moreover, some embodiments displace contents of the cartridges 18 and 20 at an equal flow rate through the cartridges. Drive 16 may include, for example, a pneumatic cylinder, a hydraulic cylinder, a linear actuator, an electric motor, such as, for example, a stepper motor or a servo motor, or a combination thereof.

In the illustrated embodiment, liquid A travels from cartridge 18 to manifold 22 then on to the liquid mixing system 14. Likewise, liquid B travels from cartridges 20 to manifold 24 where the flow from each cartridge 20 is combined into a common flow and from there proceeds to the liquid mixing system 14. In an alternative embodiment, the manifolds 22 and 24 may be omitted, allowing the liquids to travel directly from the cartridges 18 and 20 to the liquid mixing system 14. In another embodiment, the liquid mixing system 14 may be a mixing manifold which may be integral to the liquid supply system 12 or may be separate from the supply system 12. Alternatively, the liquid mixing system 14 may be integral to an applicator, such as, for example, a spray gun. After the liquids A and B are combined in the liquid mixing system 14, the combined finishing product may be applied via any suitable means, including, for example, a spray gun, a paint roller, or a paint brush, depending on the nature of the liquid mixing system 14.

Any number of cartridges 18 and 20 may be used in the liquid supply system 12. All of the cartridges 18 holding liquid A may be plumbed to the liquid mixing system via manifold 22. Likewise, all of the cartridges 20 holding liquid B may be plumbed to the liquid mixing system via manifold 24. The ratio of liquid A to liquid B may be altered by changing the number of cartridges holding each liquid. In the illustrated embodiment, there is a 1:3 ratio of liquid A to liquid B. By changing the total number of cartridges 18 and 20 and the combinations of cartridges 18 and cartridges 20, a large number of different liquid A to liquid B ratios may be obtained. For example, possible ratios may include a 1:1 ratio, 1:2 ratio, a 1:3 ratio, 1:4 ratio, a 1:5 ratio, a 1:6 ratio, and so forth. Moreover, the liquid supply system 12 may dispense contents of the cartridges 18 and 20 at equal flow rates to maintain the desired liquid ratio during flow of the liquids through the liquid mixing system 14 (e.g., an applicator such as a spray gun).

This system may be relatively inexpensive to build and maintain. By controlling the ratio of liquid A to liquid B via the number of cartridges of each component, expensive mixing systems are not necessary. In a system having a separate pump for each component in a plural-component mixture, sophisticated electronic controls may be required to ensure a correct mixture ratio because pump efficiency changes as the speed or viscosity of a fluid changes. An electronic control system may cost more than $10,000 U.S. to purchase and install, and maintenance of the system may be expensive throughout its life. In contrast, embodiments of the present invention may not include pumps, particularly separate pumps for each component. As such, independent controls for each component may not be necessary.

FIG. 2 is a block diagram of a liquid dispensing system 40 according to an embodiment of the present technique. A liquid supply system 42 supplies liquids A and B to a spray gun 44. An air supply 46 supplies air to the liquid supply system 42 and the spray gun 44. Liquid supply system 42 includes a pneumatic drive 48, which is operated using air from the air supply 46. The pneumatic drive 48 actuates a yoke 50 which drives pistons 54 via push rods 52. In certain embodiments, the pistons 54 are driven at an equal linear rate through the respective cartridges 56 and 58 in response to movement by the drive 48, yoke 50, and push rods 52. Thus, the ratio of cartridges 56 and 58 with liquids A and B and the equal linear rate of displacement provides a relatively precise ratio of the liquids A and B for subsequent mixture downstream at the spray gun 44. For example, if the pistons 54 and the cartridges 56 and 58 have the same diameter, then the equal linear rate of the pistons 54 produces an equal flow rate of the liquids A and B through the cartridges 56 and 58.

The pistons 54 are positioned in cartridges 56 and 58. Liquid A travels from cartridges 56 to manifold 60, where the flows are combined to a common flow which then travels to spray gun 44. Similarly, liquid B travels from cartridges 58 to spray gun 44 via manifold 62. Once in the spray gun 44, liquids A and B are combined to produce a finishing product 64. Air supply 46 atomizes the finishing product 64 to create a spray which may be applied, for example, to cars, airplanes, space shuttles, manufacturing equipment, or any other appropriate surface.

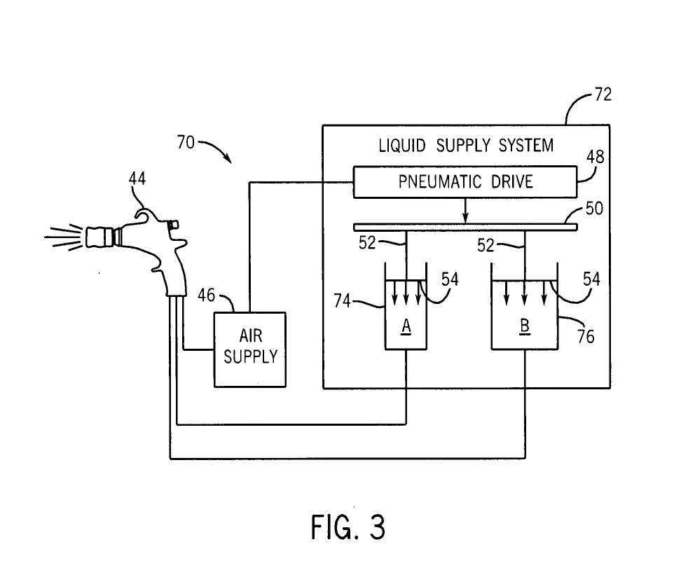

FIG. 3 is a block diagram of a liquid dispensing system 70 according to an alternative embodiment of the present technique. As discussed above in reference to FIG. 2, a liquid supply system 72 supplies liquids A and B to a spray gun 44 by the use of a pneumatic drive 48. Air supply 46 activates the pneumatic drive 48, causing the yoke 50 to push the pistons 54 via the push rods 52. As yoke 50 is pushed down, push rods 52 and pistons 54 move down at the same linear rate. The ratio of liquid A to liquid B entering the spray gun 44 is therefore determined by the size (e.g., cross-sectional area) of cartridges 74 and 76. Because the cartridge 74 holding liquid A is half the size (e.g., cross-sectional area) of the cartridge 76 holding liquid B, there is a 1:2 ratio of liquid A to liquid B flowing from the cartridges 74 and 76. This ratio may be adjusted by using different sizes and numbers of cartridges 74 and 76. In other words, the mixture ratio is controlled by an equal linear displacement rate in the various cartridges, the ratio of cartridges with different liquids, and the size of these cartridges rather than independently controlling the drive rate (e.g., piston rate) for each cartridge.

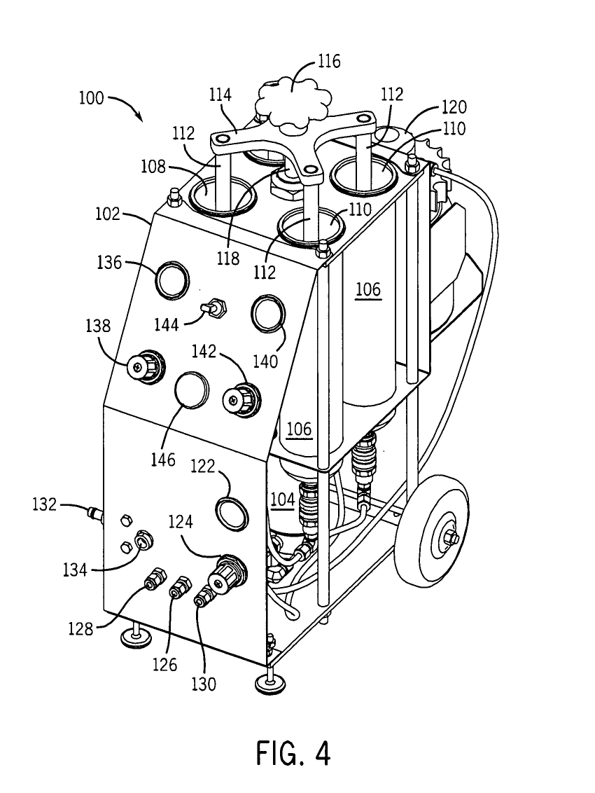

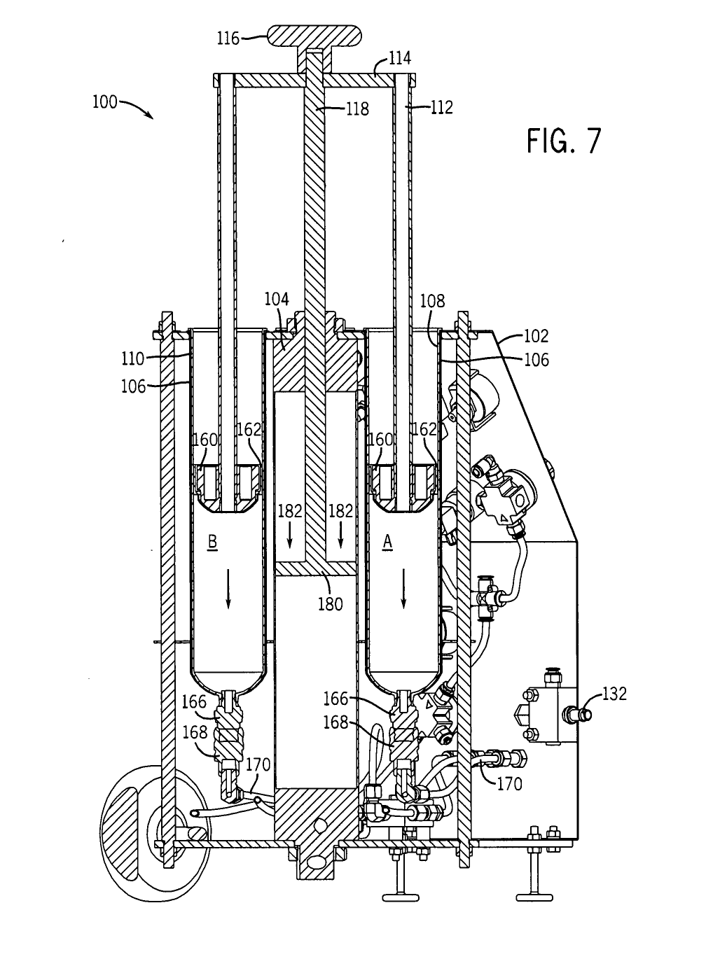

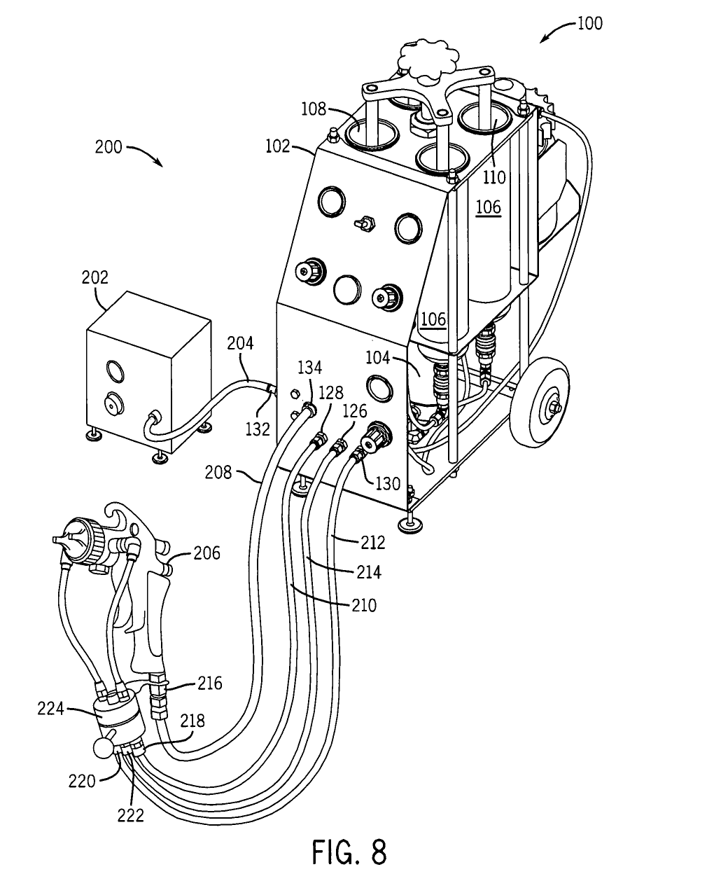

FIG. 4 is a perspective view of a liquid supply system 100 according to an embodiment of the present technique. For example, the system 100 may represent an embodiment of one or all of the systems illustrated in FIGS. 1-3. The liquid supply system 100 includes a support structure 102. A pneumatic drive cylinder 104 is situated between a plurality of cartridge receptacles 106. This positioning of the pneumatic drive cylinder 104 enables compactness of the chassis design and a low center of gravity. In addition, any leaks from the cartridges are kept away from the pneumatic drive cylinder 104 by the lateral distance between the pneumatic drive cylinder 104 and the cartridges. Alternatively, the pneumatic drive cylinder 104 may be positioned above the cartridge receptacles 106. In one embodiment of the present technique, the pneumatic drive cylinder 104 is a three (3) inch diameter cylinder with a fourteen (14) inch stroke. Such cylinders are commercially available from various sources, such as Parker of Des Plaines, Ill., and Bimba Manufacturing of Monee, Ill. Each cartridge receptacle 106 may hold a liquid A cartridge 108, a liquid B cartridge 110, or no cartridge. As discussed above in reference to FIG. 1, different liquid A to liquid B ratios may be obtained by using different numbers and combinations of cartridges 108 and 110. Cartridges 108 and 110 may be disposable, reusable, recyclable, or any combination thereof. The cartridges 108 and 110 may be composed of a generally rigid material, such as, for example, plastic or metal, and may be generally cylindrical, mirroring the shape of the cartridge receptacles 106. In other words, embodiments of the cartridges 108 and 110 may not be collapsible flexible units, such as bags, as this configuration may impair the uniformity of flow rates needed to achieve an accurate mixture ratio, as discussed below in reference to FIG. 7. However, the cartridges 108 and 110 do collapse or displace an interior volume in a controlled and uniform manner.

Disposed within each cartridge receptacle 106 is a push rod 112. The push rods 112 are attached to the ends of arms of yoke 114, the center of which is attached to a cylinder rod 118. Yoke 114 is secured to cylinder rod 118 via a knob 116. The push rods 112 may be removably or fixedly attached to yoke 114. Knob 116 may be disengaged from cylinder rod 118, allowing yoke 114 and push rods 112 to be removed from the liquid supply system 100. This disengagement allows for removal and replacement of empty cartridges 108 and 110. In order to adjust the ratio of liquid A to liquid B in the system 100, the empty cartridges may be replaced with a different ratio of cartridges 108 to cartridges 110. Alternatively, or in addition to the ratio adjustment, cartridges of different diameters may be used within the receptacles 106. As discussed above in relation to FIG. 3, cartridges 108 and 110 having different diameters may have an equivalent linear displacement rate but a different flow rate resulting from the different cross-sectional area of the cartridges. Adapters (not shown) may be disposed within the receptacles 106 to receive cartridges 108 and/or 110 of different diameters. These adapters may be configured such that a cartridge 108 or 10 of smaller diameter may be situated in the center of the receptacle 106. In certain embodiments, this change with the adapters may not require any adjustment or repositioning of the push rods 112.

The liquid supply system 100 may further include a solvent tank 120. The solvent tank 120 is monitored and regulated by solvent gauge 122 and solvent regulator 124. Solvent tank 120 is attached to a solvent outlet 126 such that, for example, solvent may be dispensed to a spray gun for purposes of cleaning the gun or correcting application errors. The liquid supply system 100 includes similar outlets 128 and 130 for liquids A and B, respectively. These outlets 128 and 130 may be connected directly to cartridges 108 and 110, respectively, or may be connected to intermediate manifolds (not shown) configured to combine flows of similar liquids from multiple cartridges. An air supply may be connected to the liquid supply system 100 via an air inlet 132. Air which enters the system 100 through the air inlet 132 may be used to actuate the pneumatic drive cylinder 104. An air outlet 134 may branch off the air inlet 132 and supply air to a spray gun from the system 100. The pneumatic drive cylinder 104 is monitored and regulated by cylinder gauge 136 and cylinder regulator 138. Similarly, liquid flows from the cartridges 108 and 100 are monitored and regulated by fluid gauge 140 and fluid regulator 142. A toggle switch 144 controls the movement of the cylinder 104, and an emergency stop button 146 may relieve pressure to all of the devices in the system 100 except to the air outlet 134.

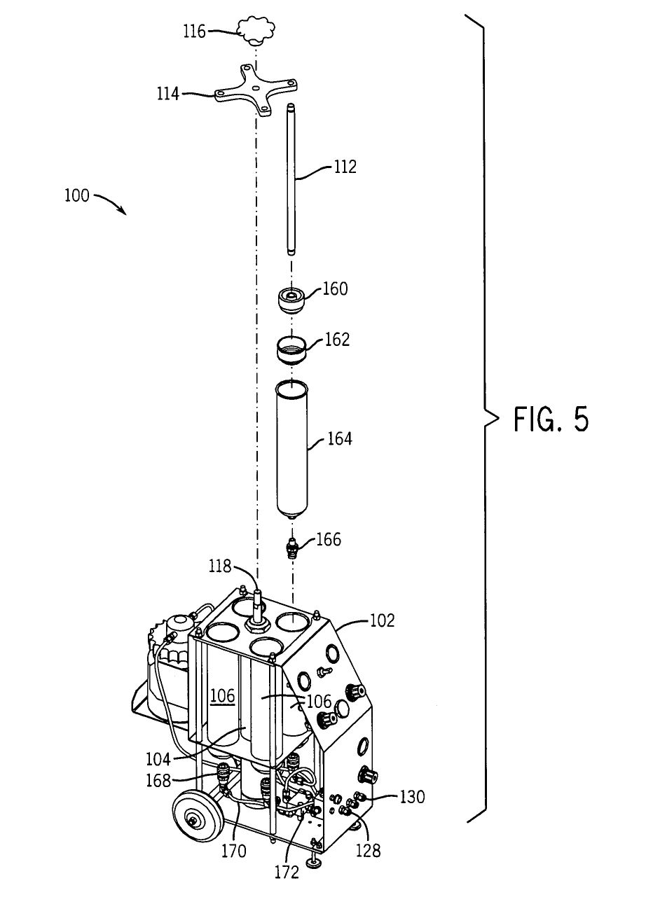

FIG. 5 is an exploded view of the liquid supply system 100 of FIG. 4. As discussed above with reference to FIG. 4, knob 116 may be disengaged to allow removal of yoke 114 and push rods 112 from the system. Each push rod 112 is attached at the distal end from yoke 114 to a piston 160. Piston 160 is configured to nest within a plunger 162, which is movably located in cartridge 164. The cartridge 164 may include cartridges 108 or 110, as described above in reference to FIG. 4. Cartridge 164 may hold a liquid, such as liquid A or liquid B, as described above. According to an embodiment of the present technique, cartridge 164 may hold 32 ounces of liquid. The cartridge 164 may be available commercially from various sources, such as PRC-DeSoto International (a PPG Industries Company) of Glendale, Calif.

Plunger 162 may be configured to seal an end of cartridge 164 after cartridge 164 has been filled with a liquid. That is, the plunger 162 may also act as an endcap that may prevent spillage of the liquid disposed within the cartridge 164 during transportation and storage of the cartridge 164. In addition, the piston 160 may be packaged with the cartridge 164 or may be provided independently of the cartridge 164. Plunger 162 may then displace the liquid within cartridge 164 when sufficient pressure is applied to move plunger 162. This pressure may be supplied by the pneumatic drive cylinder 104 via the cylinder rod 118, the yoke 114, the push rod 112, and the piston 160. At the distal end from the plunger 162, the cartridge 164 may be sealed by a membrane (not shown). Upon engagement of the cartridge 164 within the system 100, the membrane may be pierced by a male quick disconnect fitting 166. The male quick disconnect fitting 166 may be easily attached to a female quick disconnect fitting 168, which is connected to a conduit 170. Depending on the nature of the cartridge 164, that is, whether the cartridge 164 holds liquid A or liquid B, and the number of each type of cartridge 164 in the system, the conduit 170 may be connected directly to a liquid outlet 128 or 130 or may be connected to a manifold 172. In addition, the conduit 170 may be connected to a valve (not shown) configured to route the flow of liquid from the cartridge 164 to different manifolds 172 or outlets 128 or 130 depending on what liquid is used in a given application. That is, the valve may be configured, for example, to route liquid from cartridge 164 to liquid A outlet 128 or liquid B manifold 172 depending on whether cartridge 164 holds liquid A or liquid B.

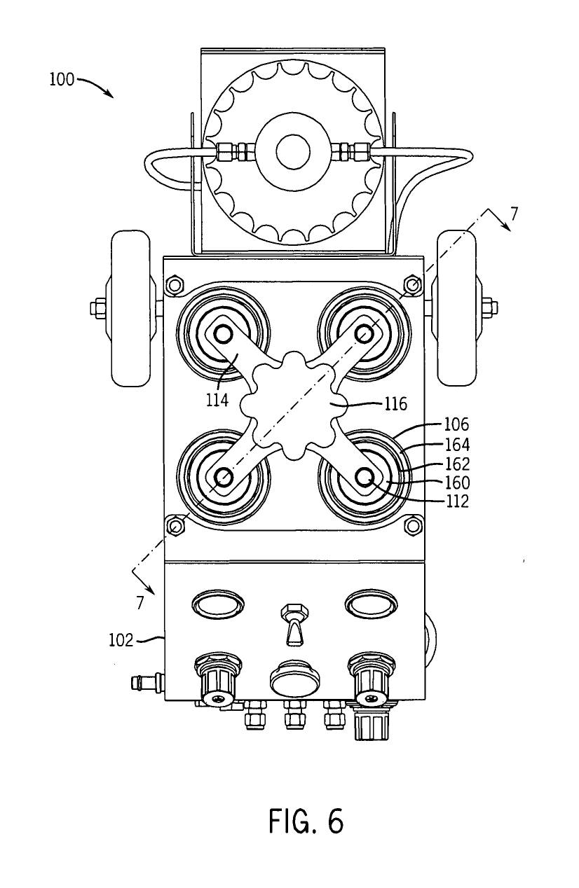

FIG. 6 is a top view of the liquid supply system 100 of FIG. 4. According to an embodiment of the present technique, the push rods 112 are each located at an equal radius from the pneumatic drive cylinder 104 and in the center of each cartridge 164. This positioning ensures that the same linear force is applied to each liquid in the system 100. Therefore, the ratio of the liquids may be controlled solely by changing the combinations of liquid A cartridges 108 and liquid B cartridges 110.

FIG. 7 is a cross-sectional view of the liquid supply system 100 of FIG. 4 taken along line 7-7 of FIG. 6. This diagonal cross-section slices through two of the cartridges 108 and 110 and through the pneumatic cylinder 104. It can be seen in this illustration that pneumatic cylinder 104 includes a cylinder piston 180. Air flows from the air inlet 132 to the top of the pneumatic cylinder 104. Air pressure 182 pushes down on the cylinder piston 180, causing the piston 180 to move the cylinder rod 118. The cylinder rod 118 then moves the yoke 114 and the attached push rods 112. The push rods 112 push down on the pistons 160, which apply pressure to the plungers 162. In the present embodiment, the plungers 162 move at an equal linear rate through the cartridges 108 and 110. As the plungers 162 move down through the cartridges 108 and 110, the liquids A and B are displaced in a direction 184. Because the plungers 162 are directly in contact with the liquids A and B contained in the cartridges 108 and 110, the equal linear movement of the plungers 162 translates to an equal linear displacement of the liquids A and B. In a system where the liquids are contained in bags, the pressure on the bags by plungers 162 may not translate evenly due to variations such as space between the bag and the receptacle 106, interference when the volume of the bag is significant in comparison to the remaining volume of the liquid, and liquid getting trapped in areas of the bag as the bag compresses. According to the present embodiment, liquid flows through the male and female quick disconnect fittings 166 and 168 to the conduits 170. According to an embodiment of the present technique, all of the conduits 170 are the same length, minimizing air entrapment downstream when new cartridges 108 and 110 are engaged in the system 100.

FIG. 8 is a perspective view of a liquid dispensing system 200 according to an embodiment of the present technique. The liquid supply system 100 may be connected to an air compressor 202 via an air conduit 204 connected to the air inlet 132. System 100 may be connected to a spray gun 206 via a plurality of air and liquid conduits. Air from the air outlet 134 travels through an air conduit 208 to supply air to an air inlet 216 of the spray gun 206. Liquids A and B travel from outlets 128 and 130 through conduits 210 and 212 to inlets 218 and 220, respectively. Likewise, solvent travels from outlet 126 through conduit 214 to inlet 222. Spray gun 206 may include a solvent selector system 224, such as that described in U.S. App. Serial No. 2004/0056045 A1, titled “Two-Component Spray Gun with Solvent Flush/Blend” and filed on Sep. 25, 2002, by Michael J. Kosmyna et al., herein incorporated by reference in its entirety.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A finishing dispenser system, comprising:
a multi-cartridge support configured to receive a plurality of finishing component cartridges in a proportion to control a mixture ratio of a plurality of different finishing components;
a drive configured to displace fluid at an equal linear rate in the plurality of finishing component cartridges; and
an outlet for each different finishing component.

2. The system of claim 1, wherein the plurality of different finishing components comprise paint, resin, hardener, catalyst, or a combination thereof.

3. The system of claim 1, wherein the drive comprises a pneumatic cylinder, a hydraulic cylinder, a linear actuator, an electric motor, a stepper motor, a servo motor, or a combination thereof.

4. The system of claim 1, wherein the multi-cartridge support is configured to receive four finishing component cartridges in any ratio of at least two different finishing components.

5. The system of claim 1, wherein the multi-cartridge support is configured to receive cylindrical finishing component cartridges of the same length and diameter.

6. The system of claim 1, wherein the multi-cartridge support is configured to receive cylindrical finishing component cartridges of the same length but different diameters.

7. The system of claim 1, wherein the multi-cartridge support is configured to orient the plurality of finishing component cartridges at an equal radius around the drive.

8. The system of claim 1, comprising a finishing applicator configured to separately receive the plurality of different finishing components, to combine the plurality of components into a finishing mixture, and to apply the finishing mixture to a surface.

9. A finishing dispenser system, comprising:
a multi-cartridge support having a plurality of uniformly sized tubular finishing component receptacles configured to receive non-uniformly sized tubular finishing component cartridges; and
a drive configured to displace a plurality of pistons at an equal linear rate within the plurality of receptacles.

10. The system of claim 9, wherein the plurality of uniformly sized tubular finishing component receptacles are spaced evenly at equal radii around the drive.

11. The system of claim 9, wherein a finishing mixture ratio is determined by a proportion of different finishing component cartridges placed within the plurality of uniformly sized tubular finishing component receptacles.

12. The system of claim 9, comprising a plurality of adapters configured to mount inside the plurality of uniformly sized tubular finishing component receptacles and configured to accept the non-uniformly sized tubular finishing component cartridges, wherein the non-uniformly sized tubular finishing component cartridges comprise cartridges of different diameters and uniform lengths.

13. The system of claim 9, wherein the drive comprises a pneumatic cylinder, a hydraulic cylinder, a linear actuator, an electric motor, a stepper motor, a servo motor, or a combination thereof.

14. The system of claim 9, wherein the drive is configured to displace the plurality of pistons via a yoke having a plurality of push rods proximal to the pistons, wherein the yoke is coupled to the drive.

15. The system of claim 14, wherein the yoke is detachable from the drive to enable placement of the finishing component cartridges in the plurality of uniformly sized tubular finishing component receptacles.

16. The system of claim 9, wherein the multi-cartridge support is configured to enable placement of the non-uniformly sized tubular finishing component cartridges in the plurality of uniformly sized tubular finishing component receptacles without repositioning the push rods.

17. A finishing dispenser system, comprising:
a multi-cartridge support comprising a plurality of receptacles;
a plurality of finishing component cartridges disposed in the plurality of receptacles, wherein the finishing component cartridges independently hold different finishing components, and wherein a mixture ratio of the different finishing components is based on a cartridge ratio of the finishing component cartridges having the different finishing components; and
a drive configured to displace contents of the finishing component cartridges for subsequent mixing in the mixture ratio as the different finishing components flow and merge downstream.

18. The finishing dispensing system of claim 17, wherein the receptacles are spaced evenly at equal radii around the drive.

19. The finishing dispensing system of claim 17, wherein the drive comprises a pneumatic cylinder, a hydraulic cylinder, a linear actuator, an electric motor, a stepper motor, a servo motor, or a combination thereof.

20. The finishing dispensing system of claim 17, wherein the finishing component cartridges are disposable, reusable, or recyclable, or a combination thereof.

21. The finishing dispensing system of claim 17, wherein the finishing component cartridges are tubular with a uniform length and diameter.

22. The finishing dispensing system of claim 17, wherein the finishing component cartridges are tubular with a uniform length and non-uniform diameter.

23. The finishing dispensing system of claim 17, wherein the finishing component cartridges are generally cylindrical and generally rigid.

24. The finishing dispensing system of claim 17, wherein the finishing component cartridges do not comprise bags.

25. The finishing dispensing system of claim 17, wherein the finishing component cartridges are configured to receive pistons and wherein the pistons are coupled to the drive.

26. A method, comprising positively displacing different finishing substances at an equal linear rate independently through different cartridges at a cartridge ratio that controls a downstream mixture ratio of the different finishing substances.

27. The method of claim 26, comprising mixing the different finishing substances in an applicator as the different finishing substances flow through the applicator to apply a finish of the downstream mixture ratio.
